(19) United States
(12) Patent Application Publication
(10) Pub. No.: US 2003/0100265 A1
(43) Pub. Date: May 29, 2003

(54) Signal jitters detection system and its correction method

(76) Inventors: King-Yin Wang, Kaohsiun Hsien (TW); Chi-Hsiang Wang, Taoyuan Hsien (TW); Chao-Ming Huang, Taipei Hsien (TW); Shuh-Tai Lu, Taoyuan Hsien (TW)

Correspondence Address: BIRCH STEWART KOLASCH & BIRCH, PO BOX 747, FALLS CHURCH, VA, 22040-0747, US

(21) Appl. No.: 10/073,588

(22) Filed: Feb. 14, 2002

(30) Foreign Application Priority Data
Nov. 23, 2001 (TW) 90128992

(51) Int. Cl. H04B 17/00

(52) U.S. Cl. 455/67.3

(57) ABSTRACT

A signal jitters detection system and its correction method are disclosed to detect minute time intervals (called “jitters”) between a clock signal and the upper and lower ends of a high-speed data stream. The system uses an optical head to read out an approximate relation between the amplitude variation and time variation of a radio frequency (RF) signal around the central level of an analog RF signal. Such a voltage difference is equalized as a time difference to obtain signal the jitters.

### BACKGROUND OF THE INVENTION

1. Field of Invention

The invention relates to a signal jitters detection system and its correction method used in detecting signal jitters of a data stream in a high-speed digital system and, in particular, to a signal jitters detection device that equalizes a voltage difference as a time difference and the corresponding method.

2. Related Art

In the past few years, jitters have become a signal characteristic that receives wide attentions from engineers. This is due to the fact that in high-speed digital systems, the rise time of a signal becomes shorter and shorter and therefore slight variations at the signal rise or fall edge will have a greater influence for each Mbps (megabits per second) increase in the system operating speed. The skew or data jitters in signal waveforms do no only affect the integrity of data and the setup time and hold time of signal voltages, but also make it hard for the system to maintain both the transmission speed and distance of the signals. In the end, design engineers can only make a low-efficiency product.

Jitters are not only used to evaluate the quality of an optical drive, they also serve as a reference for a servo to adjust its parameters. The application of optical drives (including DVD, VCD and CD drives) has long made them the symbol for AV multimedia. Many video games have been equipped with DVD-ROM and are rapidly developing in recent years. Although the optical drives cannot avoid the needs of high storage capacity and high storage speed, the very few companies in the industry have professional optical drive correction tools. In view of this, the ability to measure signal jitters is relatively important.

Conventional jitters detection techniques for optical drives include the following three methods. (1) The pulse counting method: It directly uses a counting pulse with a high speed to count the time interval between two signal pulses. The varying counting pulse number is recognized as the jitters. (2) The integration method: This method uses a fast integration circuit to convert the time interval between two signal pulses into a voltage variation. An A/D (Analog/Digital) converter then takes the voltage variation as the jitters. (3) The oscilloscope method: This method directs RF signal pulses to the oscilloscope, from which one observes the clearness of an eye pattern.

For a data stream in a high-speed optical drive, the frequency of the data stream is high and therefore the pulsing counting method requires a counting pulse with an even higher speed in order to detect jitters. Furthermore, the resolution of signal jitters is limited to the frequency of the counting pulse. The fast integration method also requires a larger bandwidth and is susceptible to saturation or drift effects of the circuit. Therefore, for the adjustment in the servo of a high-speed optical drive, the third method is usually employed to directly see signal jitters from an oscilloscope. Nevertheless, observation through naked eyes cannot quantify signal jitters and immediately provide a reference for the servo to adjust its parameters.

### SUMMARY OF THE INVENTION

To solve the above problems, the invention provides a signal jitters detection system and its correction method. It can detect jitters in the data streams read out by an optical drive and provide a reference for a servo to adjust its control parameters.

The disclosed signal jitters detection system and its correction method separately measure the time interval between the variations at the upper and lower edges of a digital sliced signal and the RF voltage variation of a reference pulse near a central level signal. The system contains a data slicer, a data PLL (Phase-Locked Loop), a logic control, memory, a counter, and a microprocessor. The data slicer provides a central level signal for an analog RF signal and uses the central level signal to convert the analog RF signals into digital sliced signals. The data PLL generates stable reference pulses. Two A/D converters can sample the analog RF signals and the central level signals. The logic control accepts the triggers from digital slice signals to drive the A/D converters to sample data, and outputs a latch signal and a direction signal for recording the triggering position of the trigger. The memory stores RF signals, the sampling and direction signals of the central level signal. The counter receives and counts the latch signals from the logic control, and outputs the result as a memory address. The microprocessor controls the input, output and actions of the counter, the memory, and the A/D converter.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the disclosed signal jitter detecting device;

FIG. 2 is a schematic view of the signal waveform;

FIG. 3 is a schematic view of the disclosed data slicer;

FIG. 4 is a schematic view of the disclosed data PLL;

FIG. 5 is a schematic view of voltage variation of the analog RF signal within a measured pulse period;

FIG. 6 is a schematic view of the waveform in FIG. 5;

FIG. 7 is a schematic view of a delayed sample signal; and

FIG. 8 is a flowchart of the steps for correcting signal jitters.

### DETAILED DESCRIPTION OF THE INVENTION

The data read by an optical drive pickup head from a disk is pre-amplified to generate an analog radio frequency (RF) signal. The analog RF signal is then encoded by a slicer into a binary signal, becoming a sliced signal Sliced_RF. According to the signal jitters detection system and its correction method, the signal jitters are defined according to the DVD specifications as the periods of the variation time intervals at the upper and lower ends of the sliced signal relative to a reference pulse PLCK (PLL Clock Signal). As we learn from the optics, the amplitude variation is roughly proportional to the time variation when the RF signal is around its central level. When jitters occur in the data stream, the voltage of the RF signal also varies. Therefore, when detecting the signal jitters, the variation time intervals at the upper end and lower ends of the sliced signal and the voltage the RF signal variation of a reference pulse period around the central level of an analog RF signal are separately measured.

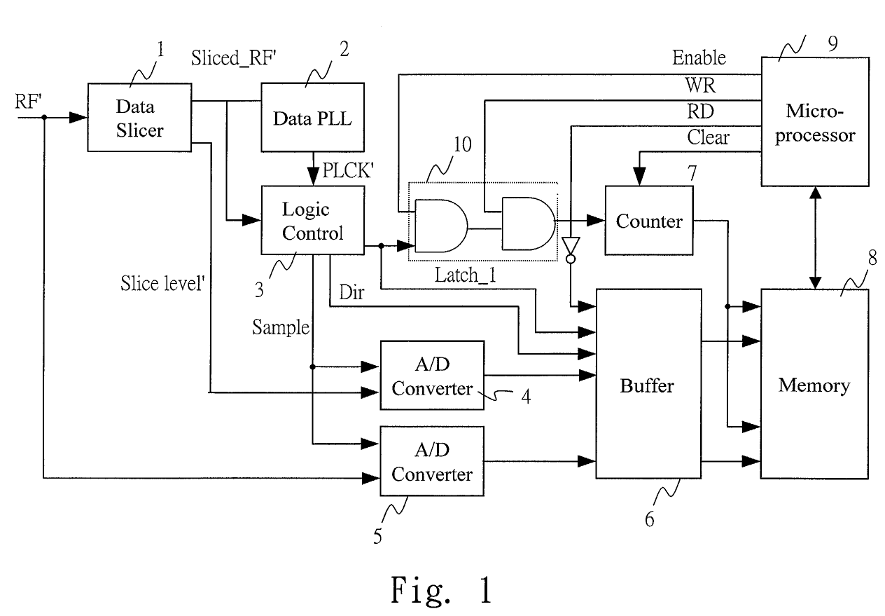

As shown in FIG. 1, the data read by an optical drive pickup head from a disk is pre-amplified to generate an analog RF signal RF′, which is then output to a detecting device provided by the invention. Due to the influence of servo control errors, signal interferences, disk drive assembly errors, disk defects, errors and noises of the optical chancel model, the analog RF signal RF′ has high frequency jitters. Through a data slicer 1, the RF signal RF′ is converted into a digital sliced signal Sliced_RF′, which is then adjusted by a data PLL (Phase-Locked Loop) to produce a stable reference pulse PLCK′. If, relative to the reference pulse PLCK′, the upper end trigger and the lower end trigger of the sliced signal Sliced_RF′ can occur within a minute time interval, then we call this phenomenon the signal jitters. The invention mainly uses the fact that the times when the upper end trigger and the lower end trigger of the digital sliced signal Sliced_RF′ appear have a approximately linear relation with the variation of the analog RF signal RF′ to compute this minute time interval.

First, the digital sliced signal Sliced_RF′ output from the data slicer 1 and the reference pulse PLCK′ output from the data PLL 2 are output to a logic control 3. Through logic operations, a sample signal Sample, a direction signal Dir, and a latch signal Latch_1 are produced. The sample signal Sample is used for an A/D (Analog-to-Digital) converter 5 to sample the analog RF signal RF′ and an A/D converter 4 to sample the central level signal Slice level′ of the analog RF signal RF′. Only when an upper end trigger or a lower end trigger of the sliced signal Sliced_RF′ appears will a pulse occurs in the latch signal Latch_1. It is used to be an input signal of a counter 7 and allows the output data from the A/D converters 4, 5 to be transferred to memory 8 through a buffer 6. The direction signal Dir records whether the digital sliced signal Sliced_RF′ has an upper end trigger or a lower end trigger and outputs it to the buffer 6. The output from the counter 7 serves as an address control for the memory 8.

When the detected signal jitters are sent into the memory 8, a microprocessor 9 first sends out a clear signal Clear to clear the counter 7 to zero the memory address. The output signals Enable, WR, and RD are high levels. The signals Enable and WR allow the latch signal Latch_1 to enter the counter 7. The signal RD allows the output data from the A/D converters 4, 5 and the direction signal Dir to be sent to the memory 8. When an upper end trigger (or a lower end trigger) of the digital sliced signal Sliced_RF′ occurs, the sample signal Sample triggers the A/D converters 4, 5 to read the central level signal Slice level′ and the analog RF signal RF′, respectively. Afterwards, the latch signal Latch_1 sends the sampled values to the memory 8 and the counter is added by one.

On the other hand, when the microprocessor 9 reads data in the memory 8 to compute signal jitters, the signal Enable is set to a low level and the latch signal Latch_1 cannot pass through an AND gate 10 to enter the counter 7. A low level signal RD is sent to the buffer 6 so that the data read by the A/D converters 4, 5 are not allowed to reach the memory 8. Afterwards, the signal WR is varied to change the output from the counter 7. The values stored in the memory 8 are all output to the microprocessor for operations. At the moment, the magnitude of the jitters of the digital sliced signal Sliced_RF′ is proportional to the sampled analog RF signal RF′ minus the central level signal Slice level′.

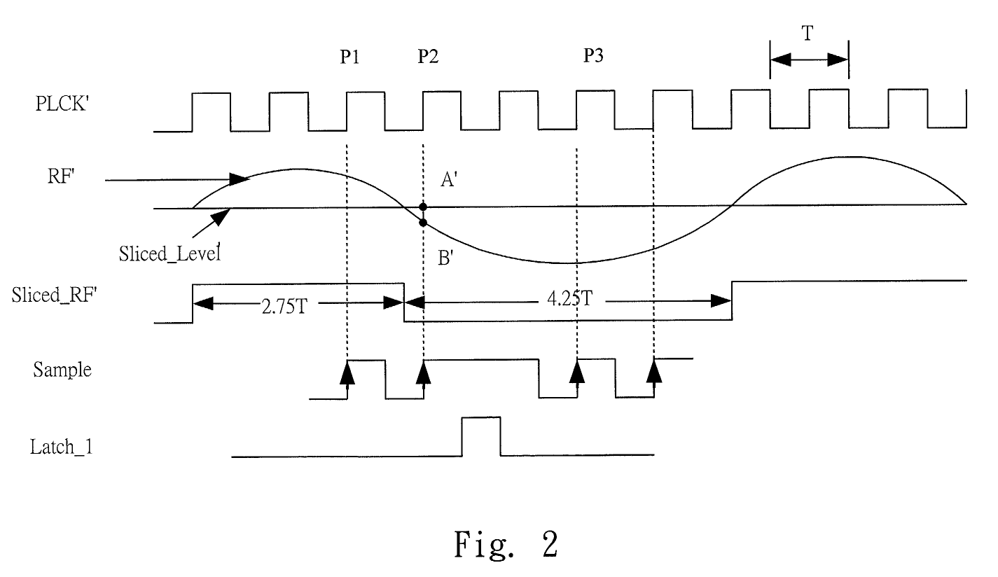

With reference to FIG. 2, suppose the reference pulse PLCK′ has a period T, the output signals Enable, WR, and RD from the microprocessor 9 are all at high levels, the A/D converters 4, 5 use the upper end trigger of the sample signal Sample, and the analog RF signal RF′ has 0.25T signal jitters. There are no signal jitters at both the upper and lower ends of the digital sliced signal Sliced_RF′ within roughly ±0.5T of the first sample point P1. The sample signal Sample is then varied with the reference pulse PLCK′ and the latch signal Latch_1 is still kept at a low level. Since the lower end (or the upper end) of the digital sliced signal Sliced_RF′ within ±0.5T of the second sample point P2 has signal jitters, the sample signal Sample is kept at a high level for 1.5T. The latch signal Latch_1 has a pulse signal for 0.5T at a distance of 0.5T from the second sample point P2. The A/D converter 4 samples the voltage of the central level signal Slice level′ at the sample point A′, and the A/D converter 5 the signal of the analog RF signal RF′ at the sample point B′. At the lower end of the latch signal Latch_1, the output data from the A/D converters 4, 5 are transmitted to the memory 8 and trigger the counter 7 to add the address in the memory 8 by 1. Within about ±0.5T of the third sample point P3, there are not signal jitters appearing in the upper end or lower end of the digital sliced signal Sliced_RF′. Therefore, the sample signal Sample is varied with the reference pulse PLCK′ and the latch signal Latch_1 is still kept at a low level.

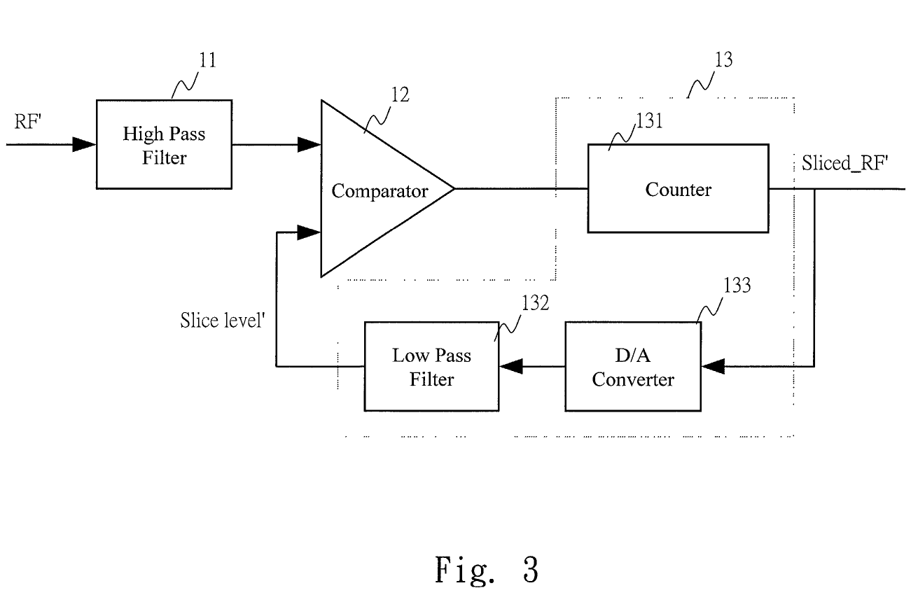

The data slicer 1 is comprised of a high pass filter 11, a comparator 12 and a digital central level corrector 13 (see FIG. 3). The digital central level corrector 13 is composed of a counter 131, a D/A (Digital-to-Analog) converter 133 and a low pass filter 132. The purpose is to provide the central level signal Slice level′ of an analog RF signal RF′. The comparator 12 is used to convert the analog RF signal RF′ into a digital sliced signal Sliced_RF′ according to the central level signal Slice level′.

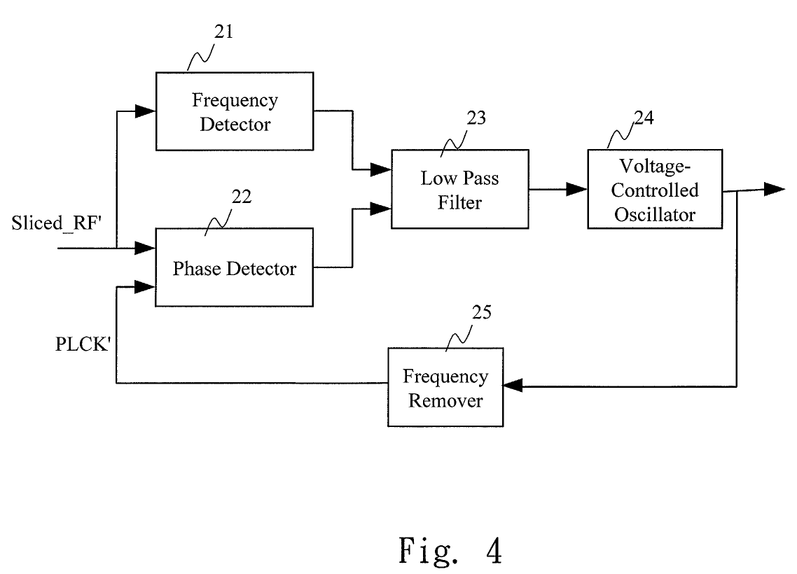

The data PLL 2 contains a phase detector 22, a frequency detector 21, a low pass filter 23, a voltage-controlled oscillator 24, and a frequency remover 25, as shown in FIG. 4. Its purpose is to generate a stable reference pulse PLCK′ according to the entered digital sliced signal Sliced_RF′.

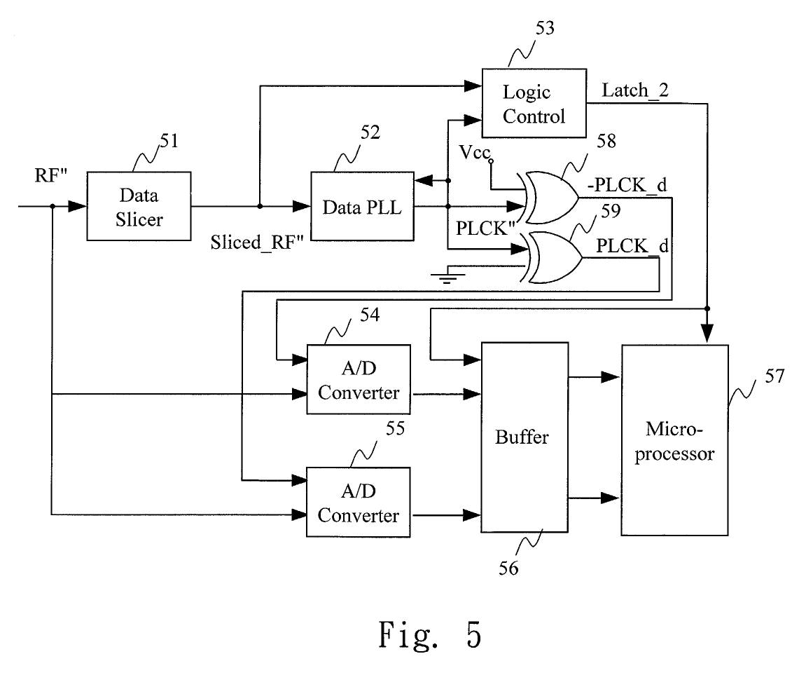

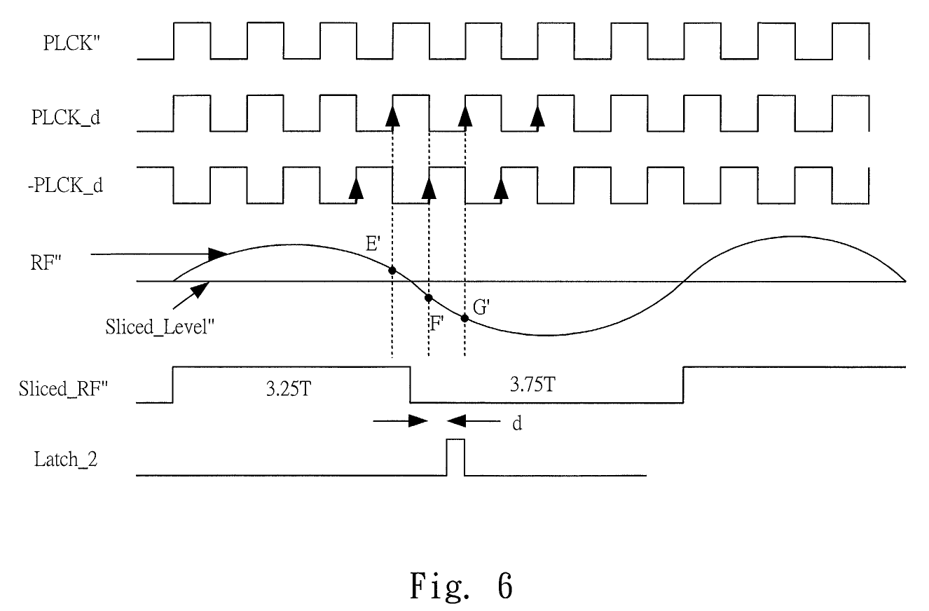

Please refer to FIG. 5 for detecting the voltage variation of an analog RF signal of a reference pulse near the central level of the analog RF signal. Suppose the A/D converters 54, 55 are both triggered by the upper end to sample data. The reference pulse PLCK″ generated by the data PLL 52 passes through two XOR gates 58, 59 and generates the reference pulses PLCK_d and −PLCK_d, whose phases differ by 180 degrees. With reference to FIG. 6, the two reference pulses PLCK_d and −PLCK_d trigger the A/D converters 54, 55 to sample the analog RF signal RF″ so that the RF signal RF″ sampled by the A/D converters 54, 55 differ by ½ period of the reference pulse PLCK″ (i.e. ½T). The reference pulse PLCK″ and the digital sliced signal Sliced_RF″ are output to the logic control 53. When jitters occur to the upper or lower end of the digital sliced signal Sliced_RF″, the logic control 53 delays time d to output a latch signal Latch_2 after the upper or lower end of the next reference pulse PLCK″ appears. The latch signal Latch_2 locks the data output from the A/D converters 54, 55 (data at the sample points E′ and F′) into the buffer 56. The microprocessor 57 is notified to process data in the buffer 56. Moreover, when the logic control 53 detects jitters at the lower end of the digital sliced signal Sliced_RF″, a latch signal Latch_2 is delayed by 0.25T before it is output. The high level of the latch signal Latch_2 is also maintained for 0.25T. The delay time d of the latch signal Latch_2 has to be long enough for the A/D converters 54, 55 to complete the conversions and before the next sample point G′ occur. Although there care offsets for both values read by the A/D converters 54, 55, the voltage variation of the analog RF signal RF″ of the ½ reference pulse PLCK″ produced by taking the difference of the two values can cancel the offsets. The result multiplied by two is the voltage variation of the RF signal RF″ of a reference pulse PLCK″ near the central level of the desired analog RF signal RF″. Therefore, by measuring the jitters of the digital sliced signal Sliced_RF and detecting the voltage variation of the analog RF signal RF″ of a reference pulse PLCK″, the microprocessor can compute the signal jitters.

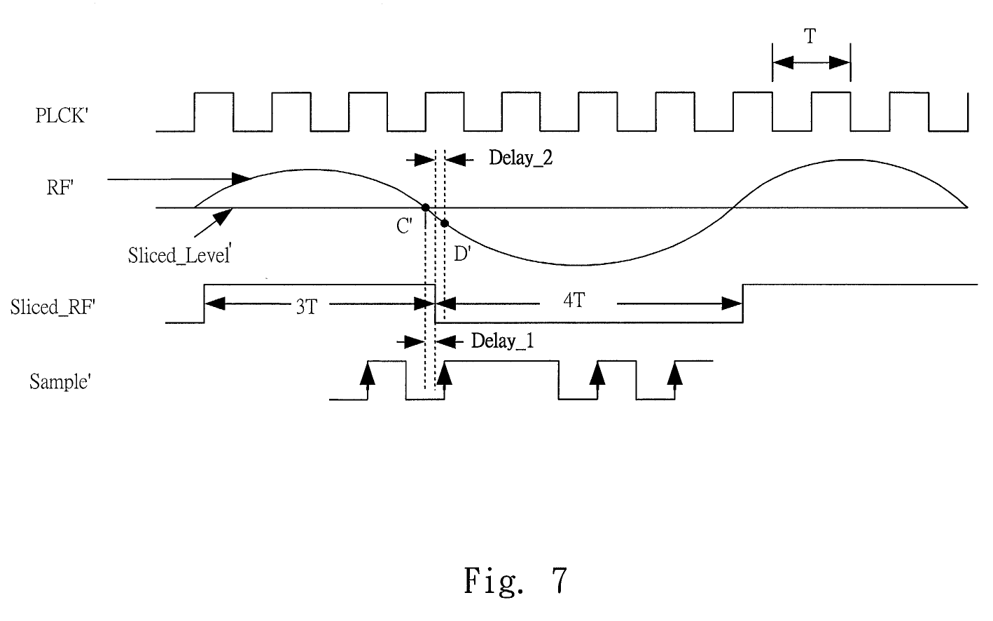

Although the variation of the analog RF signal RF′ can be used to learn the time interval of the jitters of the digital sliced signal Sliced_RF′, it takes time for the comparator 12 to convert the analog RF signal RF′ into a digital sliced signal Sliced_RF′ and for the logic control 3 to compute a sample signal Sample. Therefore, there is a time delay for producing the sample signal Sample. Using the sample signal Sample to trigger the A/D converters 4, 5 to read the analog RF signal RF′ and the central level signal Slice level′ may result in a fixed offset in the value of the detected analog RF signal RF′. With reference to FIG. 7, if the comparator 12 sets a delay time Delay_1 for converting the analog RF signal RF′ into a digital sliced signal Sliced_RF′ and the time delay for the logic control 3 to computes the sample signal Sample′ is Delay_2, then the sample point of the analog RF signal RF′ is shifted from the original point C′ to the point D′. The shifting direction is related to the upper end or lower end trigger of the digital sliced signal Sliced_RF′. When the digital sliced signal Sliced_RF′ uses its upper end to trigger, the sampled analog RF signal RF′ is larger; whereas if the digital sliced signal Sliced_RF′ uses its lower end to trigger, the sampled analog RF signal RF′ is smaller. Therefore, the time delay has to be compensated.

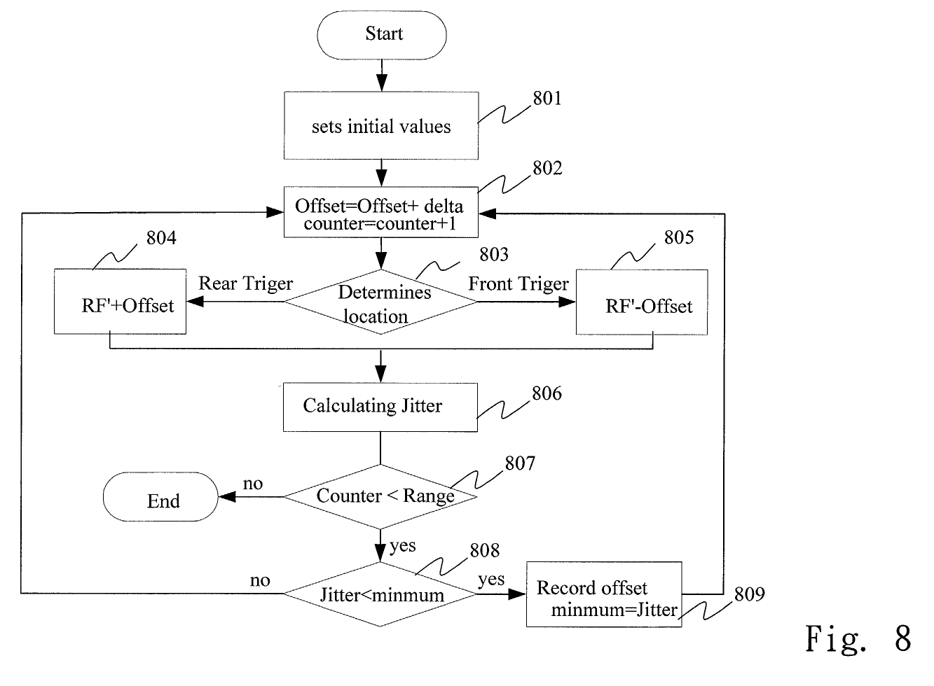

As shown in FIG. 8, step 801 sets initial values of a delta of the wander compensation, a range of times, an offset and a counter. In step 802, the offset is set to be equal to the sum of the original offset and the delta of the wander compensation, and the counter is added by one. Step 803 determines the location of a signal jitter. The direction signal Dir is used to determine whether the signal jitter occurs at the upper or lower end of the signal. If it is determined to be caused by an upper end trigger of the digital sliced signal Sliced_RF′, the offset value is subtracted from the extracted value RF′ in step 805. If the direction signal Dir indicates that it is a lower end trigger, then the offset value is added to the extracted value RF′ in step 804. Step 806 computes the signal jitter in a statistical way. Step 807 determines whether the result falls within the range of times. In the compensation range, a offset with the least signal jitter is found in steps 808, 809 to be the RF′ variation caused by the circuit delay. The above procedure thus completes a signal jitter correction.

### EFFECTS OF THE INVENTION

The invention discloses a system for detecting signal jitters and its correction method. The integration or counting methods to detect signal jitters in the prior art directly compare the phase difference between two high-speed pulses. The only difference is that the amplification method is done by integration or counting, the operating frequency of the detection system thus has to be greater than that of the optical disk drive.

From optical properties, one knows that the amplitude variation and time variation of an RF signal near its central level have approximately a linear relation. Such a voltage difference is thus equal to a time variation. When signal jitters occur to a data stream, the RF voltage measured by the A/D converter also varies.

For high-speed or future high-capacity disk drive, the invention detects their signal jitters by measuring the upper and lower ends of the data stream. Therefore, the operating frequency of the detection circuit can be lower and thus more reliable. Moreover, the detected signal jitters can be quantified. If the detection module is integrated into a servo DSP, the designer is allowed to automatically adjust and get needed servo parameters directly according to the magnitude of the signal jitters.

What is claimed is:

1. A signal jitters detection system for detecting jitters of an analog RF (Radio Frequency) signal, which comprises:
a data slicer providing a central level signal for the analog RF signal and using the central level signal to convert the analog RF signal into a data sliced signal;
a data PLL (Phase-Lock Loop) generating a reference pulse;
two A/D (Analog-to-Digital) converter sampling the analog RF signal and the central level signal respectively;
a logic control receiving a trigger of the digital sliced signal to drive the A/D converter to sample signals and outputing a latch signal and a direction signal storing a trigger position of the digital sliced signal;
a memory storing the sample and direction signals of the analog RF signal and the central level signal;
a counter receiving and counting the latch signal of the logic control and outputs the result as an address of the memory; and
a microprocessor controlling inputs, outputs, and actions of the counter, the memory and the A/D converters.

2. The system of claim 1, wherein the trigger position of the digital sliced signal is the upper end of the digital sliced signal.

3. The system of claim 1, wherein the trigger position of the digital sliced signal is the lower end of the digital sliced signal.

4. The system of claim 1 further comprising a buffer, which sends the sampled signals and the direction signal of the analog RF signal and the central level signal to the memory according to the signal transmitted from the microprocessor and the logic control.

5. A signal jitters detection system using a detector to detect voltage variation of an analog RF signal within a reference pulse period, which comprises:
a data slicer providing a central level signal for the analog RF signal and using the central level signal to convert the analog RF signal into a data sliced signal;
a data PLL (Phase-Lock Loop) generating a reference pulse;
two A/D (Analog-to-Digital) converters sampling the analog RF signal and the sample points are before and after the digital sliced signal triggers;
a logic control, which, after the digital sliced signal is detected to have a trigger, delays a latch signal output by a time unit after a next reference pulse occurs; and
a microprocessor receiving the latch signal and process the sampled signal in the A/D converters.

6. The system of claim 5, wherein the two sample points are separated by one period of the reference pulse.

7. The system of claim 5, wherein the two sample points are separated by one half period of the reference pulse.

8. The system of claim 5, wherein the two sample points are separated by twice the period of the reference pulse.

9. A signal jitter correction method, which comprises the steps of:
setting a range of wander compensation, a range of number of times, and initial values of the wander value and the number of times;
determining the location where signal jitters happen;
computing the signal jitters in a statistical way; and
taking a wander value with the smallest signal jitters within the range of wander compensation as a voltage variation.
